(19) United States
(12) Patent Application Publication
(10) Pub. No.: US 2006/0228682 A1
(43) Pub. Date: Oct. 12, 2006

(54) Three dimensional model for protein or part of protein structure

(76) Inventors: Richard Charles Garratt, Sao Carlos (BR); Luciano Douglas Dos Santos Abel, Sao Carlos (BR)

Correspondence Address: BROOKS KUSHMAN P.C., 1000 TOWN CENTER, TWENTY-SECOND FLOOR, SOUTHFIELD, MI, 48075, US

(21) Appl. No.: 10/545,697

(22) PCT Filed: Feb. 18, 2004
(86) PCT No.: PCT/BR04/00014

§ 371 Date: Aug. 16, 2005

(30) Foreign Application Priority Data
Feb. 19, 2003 (BR) 0300610-7

(51) Int. Cl. G09B 23/26

(52) U.S. Cl. 434/278

(57) ABSTRACT

The invention refers to modular components to be used in the construction of molecular models representing protein structures. More specifically, the invention discloses components representing parts of the protein which do not form elements of secondary structure and parts of elements of secondary structure, as well as their connections, to build models representing the fold of any protein structure, or even models which are proportional to their real size by establishing a given scale. Said models are useful for teaching purposes and for visualizing protein structure during research work in the field.

### FIELD OF THE INVENTION

The invention refers to modular components to be used in the construction of molecular models representing protein structures. More specifically, the invention discloses components representing parts of elements of the primary and secondary structure, as well as their connections, to build models representing the topology of any protein structure, whether adopting a scale or not. Said models are useful for teaching purposes and for visualizing protein structure during research work in the field.

### BACKGROUND OF THE INVENTION

Proteins are biological macromolecules composed of amino acids. They vary enormously in size and molecular weight, and may present a few to several hundred KDa. When several such molecules are joined to form a macromolecular complex, this may have a molecular weight in the MDalton range, forming molecules having hundreds of thousands of atoms.

In order to perform their various tasks within living organisms, proteins must present particular three-dimensional structures. Said structures are specific for each protein and are extremely complex at the atomic level, due to the very size of the molecules and the number of their constituent atoms.

The understanding of protein structure is therefore a complex task, but basic to the comprehension of the activity of these molecules within a living organism.

Proteins are composed of one or more polypeptide chains which, are formed by the successive condensation of the carboxylic (or α-carboxylic) acid group of one amino acid with the amine group of another. Amino acid condensation results in the formation of peptide (amide) bonds joining them in a chain which, in principle, may be of any length.

There are 20 types of natural amino acids found in proteins, which may be present in any order along the polypeptide chain. The order of amino acids forming a chain joined by peptide bonds is called the primary structure or just the amino acid sequence. Amino acids differ from each other only by the nature of the radical, also known as the side chain. Excluding the side chains, the remainder of the chain is called the backbone or main chain.

The peptide bond has the characteristics of a partial double bond, thus resulting in rigidity within the peptide unit. Consequently, the peptide unit is effectively planar and the associated dihedral angle ω (defined by the positions of the atoms Cα(i), C(i), N(i+1) and Cα(i+1), where i refers to any amino acid within the polypeptide chain) is fixed close to 180° or, more rarely, 0°. As a consequence, the only freely rotatable single bonds within the main chain of a polypeptide are the covalent bonds between the nitrogen of any given amino acid and its Cα and between Cα and the carbonyl carbon. The dihedral angles linked to these two bonds are called φ and ψ, respectively, and only a few combinations of these are stereochemically allowed.

If the combination of φ and ψ is systemically repeated along a polypeptide chain, the resulting structure will be a helix. Although a large number of such helices is theoretically possible, only a very limited number is found with a significant frequency in nature. The most important helices are the α-helix and the β-sheet strand (or simply β-strand), although other helices, such as collagen and polyproline helices, 3₁₀ and π-helices, the latter two of which are similar to the α-helix, are also known. All such helices may be characterized by a series of standard parameters including the number of residues per helical turn (n), the displacement along the helix axis per residue (d), the pitch of the helix (p=d×n) and the helix radius (r). A negative value of n indicates a left-handed helix (one which spirals anticlockwise when moving away from the observer) and a positive value of n designates a right-handed helix (one which spirals clockwise when moving away from the observer).

When a polypeptide chain folds up into its native three-dimensional structure, stretches of the chain, which assume one of these helical structures, are known as elements of secondary structures. The most common structures are α-helices and β-strands, mainly because they lead naturally to the formation of hydrogen bonds. In the case of the α-helix, hydrogen bonds are internal, formed between the carbonyl oxygens of residue i and the amino group of residue i+4. In the 3₁₀ helix, hydrogen bonds are formed between i and i+3 and, in the π-helix, between i and i+5.

In the β-strands, hydrogen bonds are not internal to the strands, but are rather formed between two strands. Two or more β-strands joined by hydrogen bonds form a β-sheet, while a two-stranded sheet is also known as a β-ladder.

The regions of proteins that do not form elements of secondary structure are used to connect such elements. They generally have irregular structures in which the φ and ψ angles do not systemically repeat, being known as loops or turns. The most important group of turns are the β-turns or reverse turns which consist of four residues. Loops may be of any length.

The full three-dimensional structure of a polypeptide chain, described by the coordinates of each one of its component atoms, is called its tertiary structure. If a protein has more than one polypeptide chain, then the arrangement of such chains is called its quaternary structure.

The inherent complexity of such structures makes their understanding difficult, leading to the use of a common simplification when producing a two-dimensional image, photograph or drawing. In general, the structure is reduced from an all-atom representation to a simplified topological representation, in which cylinders or spirals represent the α-helices (and similar) and β-strands are shown as arrows or strands. Said figures represent the fold of the peptide chain, since they preserve the correct sequence of secondary structural elements and their relative position, without providing atomic details. These representations greatly clarify the fold and may be used for teaching and literary illustration, being the object of various specific computer software such as RIBBONS (Carson, M. (1997), Methods in Enzymology 277, 493-505; J. Appl. Cryst. 24, 958), WHATIF (Vriend, G. (1990) J. Mol. Graph. 8, 52), Molscript (Kraulis, P. (1991) J. Appl. Cryst. 24, 946-950), Setor (Evans, S. V. (1993) J. Mol. Graph. 11, 134), and PyMol (Delano, W. L. http://pymol.sourceforge.net).

However, a two-dimensional representation is inadequate for the understanding of the real relationship between the component parts of the structures, the importance of the fold and for comparison between topologies. For such purposes, a three-dimensional model would be required.

Nicholson describes an all-atom representation model for protein structures made out of a large number of rigid color-coded components, as disclosed by the patent U.S. Pat. No. 3,841,001. A scale of 1 cm=1 Å is used and leads to huge models which are difficult to handle in the case of large proteins. The models must also be permanently fixed by means of a base and vertical metal rods.

The English company Cochranes commercializes a number of molecular construction systems which also use an all-atom representation but are more flexible in terms of scale. These models suffer from the disadvantage that they lead to equally large, cumbersome and very complex constructions for most applications.

Ruben and Richardson (Biopolymers III, 2313-2318, 1972) disclose models using wires. Built by bending the wire at each Cα atom, they are a simple way to represent a protein structure, but have the disadvantage of requiring special apparatus for wire bending. On the other hand, the patent U.S. Pat. No. 4,378,218 discloses that it is possible to improve on the method of Ruben and Richardson by means of a construction comprising balls and sticks and a fixed scale in which the Cα positions are joined by cylinders representing pseudo bonds between adjacent Cα atoms.

Similar systems for the construction of models based on the position of Cα atoms, commercialized by an English university company, in which residues are color-identified according to their physical properties and the scale is fixed at 1 cm=2 Å, can be found.

All mentioned models present the disadvantage that they do not escape from an explicit atomic representation, albeit simplified in some cases. Furthermore, the use of colors limits the user's choice and representations are not geared to highlighting the three-dimensional structure of the proteins, specifically their topology. None of the previously described models are similar to the two-dimensional representations commonly used in the specialized literature to overcome the problem of structural complexity.

### SUMMARY OF THE INVENTION

The present invention solves the problems of the previous art as described above, particularly the complexity and size of all-atom models or Cα representations. The simplicity of the models of the invention allows highlighting specific aspects of each structure by means of colors or materials. The flexibility introduced by adopting an adjustable scale (or no scale at all) means that the models are not limited to the representation of a specific protein structure and can schematically represent a protein fold common to various different structures. The parts composing the model of the invention are preferably made of sufficiently flexible material to accommodate the many distortions commonly observed in the elements of protein secondary structure.

One of the objects of the present invention is to provide the components for the construction of three-dimensional topological models of protein structures.

It is a further object of the present invention to apply the model simply for the construction and demonstration of the basic aspects of protein structures, such as e.g. regions of protein structures which do not form elements of secondary structure as well as secondary structures such as β-sheet strands and their chirality; β-sheets composed of more than one strand and their chirality; β-sheets forming saddles, barrels and coiled coils; β-bulges; α-helices; kinks in α-helices.

A further object of the present invention refers to the use of the components for the production of topological models of the protein structure of interest, even including quaternary structures and interaction among proteins, in which the connectivity of the elements of secondary structure, their sequence along the primary structure and their relative spatial arrangement are preserved, but with no consideration of scale.

A further object of the invention refers to components for the construction of models in scale, wherein said scale is chosen by the user.

A further object of the invention are kits for the construction of three-dimensional models to represent protein structures.

### BRIEF DESCRIPTION OF THE FIGURES

FIG. 1 shows the nine components for the construction of a three-dimensional model according to a preferred embodiment of the invention: (a) components used for the construction of the body of α- (3₁₀ or π) helices; (b) and (c) used for the terminal portions of the helices; (d) β-sheet strand body components; (e) arrowhead components used to terminate β-sheet strands; (f) connections between elements of secondary structure; (g) components representing pseudo hydrogen bonds; and (h) and (i) connections used to improve the mechanical stability of the model.

FIG. 2 shows basic elements of the secondary structure according to a preferred embodiment of the invention: (a) α-helice; (b) untwisted β-strand; (c) twisted β-strand; (d) helical twisted β-strand; (e) kinked α-helix, such as that induced by proline.

FIG. 3 shows examples of β-sheet architecture built from elements according to a preferred embodiment of the invention: (a) saddle formed by joining right-handed twisted β-strands by pseudo hydrogen bonds following a rectangular hydrogen-bond array (Salemme, F. R., (1983) 42, 95-133); (b) rhombohedral array of hydrogen bonds within the same basic architecture shown in (b), leading to the induction of a β-barrel (lighter colored elements); (c) two right-handed coiled twisted β-strands lead to the formation of a coiled-coil structure, in which the strand axes are helical; (d) β-bulge formed by introducing one additional residue into the darker color strand; (e) the pleated nature of the β-sheet can be emphasized by displacing the components in alternately opposite directions perpendicularly to the strand direction (this representation can be readily achieved by joining a series of β-strand body components and bending them into a closed circle which is reopened after some time and subsequently by rotating components by 180° with respect to one another, so to form the pleated structure).

FIG. 4 shows a TIM (Triose Phosphate Isomerase) barrel in a (a) perpendicular and (b) parallel view to the axis of the barrel.

FIG. 5 shows a NAD⁺ (Nicotinamide Adenine Dinucleotide) binding domain composed of two Rossmann folds which can be distinguished by the use of colors, which is also possible for the helix connecting them. The N-terminal region of the first helix in the sequence and the previous loop (seen at the left of the figure) are shown in lighter colors, since they were made up of components of a different color to emphasize their functional importance in NAD⁺ binding, as referring herein to the various shades of black.

FIG. 6 shows a fold known as a six-bladed β-propeller in which the four-stranded β-sheets are shown in different colours, referring herein to the various shades of black.

FIG. 7 shows the construction known as a right-handed jelly-roll: (a) represents the basic hairpin structure; and (b) represents the same structure after folding to form the jelly-roll, composed of two four-stranded anti-parallel β-sheets. In this case, the negative packing angle between the two β-sheets can be readily seen, i. e. the strands towards the back of the figure are rotated anti-clockwise by about 30° with respect to the strands towards the front part of the figure.

FIG. 8 shows two four-helix bundles: (a) a right-turning bundle with no cross-over connections (RTO) (Presnell, S. R. and Cohen, F. E. (1989) Proc. Natl. Acad. Sci. 86, 6592-6596); and (b) a similar left-turning bundle (LTO). In both cases, the sequence of the helices is color-coded and the transparent plastic strips give better mechanical strength to the model, according to a preferred embodiment of the invention.

FIG. 9 shows an α/α barrel as seen in cellulase. Once again, the transparent strips give better mechanical stability to the model.

FIG. 10 shows purine-nucleoside-phosphorylase, a trimeric structure in which the three chains are non-covalently linked and shown in different colors, referring herein to the various shades of black.

FIG. 11 shows in (a) ribonuclease on the left and porcine ribonuclease inhibitor on the right and, in (b), a model for the complex between the two proteins in which the ribonuclease fits into the central region of the inhibitor. This example shows how the model may be used to represent protein-protein interactions.

FIG. 12 shows in (a) similar constructions to those described for FIG. 4 which in (b) were built with a-helices represented by spiraled components and β-strands by straighter and planer components, showing another particular embodiment of the invention.

FIG. 13 shows, as well as 12, the representation of β-strands similar to FIG. 6 by planer and flatter components and with no connectors.

### DETAILED DESCRIPTION OF THE INVENTION

The invention refers to three-dimensional topological models to represent a protein structure or part thereof, which comprises one or more of the following components:

i) components to represent the regions of proteins not forming elements of secondary structure and which are used to join components (ii);

ii) components to represent elements of secondary structure. optionally including at least one of the following components:

iii) component for the schematic representation of hydrogen bonds;

iv) reinforcement component for the mechanical stabilization of the model.

The term “topology” refers to a representation of the three-dimensional structure of proteins preserving the order of the elements of secondary structure along the polypeptide chain(s) and their connections mediated by non-covalent bonds, but not necessarily with reference to scale.

In a preferred embodiment of the present invention, components (i) are constituted of pliable material with no memory, i. e. remaining in the established position when the force tending to deform it is withdrawn, particularly in the form of wires. In an even more particular embodiment, said wires have an inner covered filament. The inner wire can be preferably constituted of metal material, such as e. g. copper, and is preferably covered with flexible material, particularly polymeric or elastomeric material, such as used e. g. in electrical wires (FIG. 1f).

According to the present invention, components (ii) may present any shape, such as geometrical forms, strands, wires or spirals. In a preferred embodiment, components (ii) are of at least two types regarding their shape:

iia) component to represent elements of secondary structure, wherein said element being α-helices (or 3₁₀ or π helices);

iib) component to represent elements of secondary structure, wherein said element being β-strands;

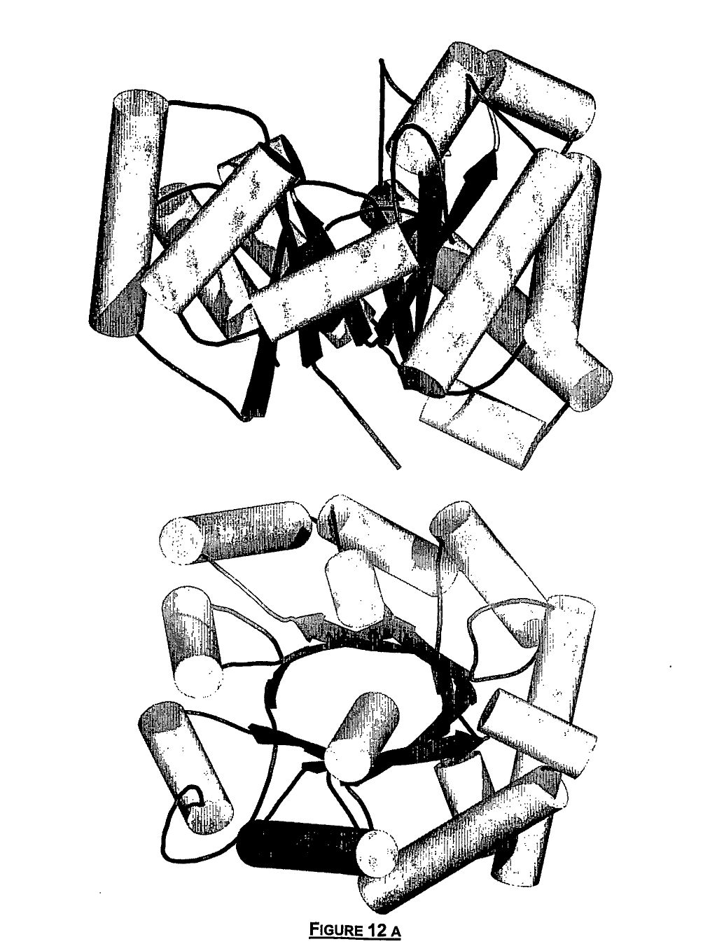

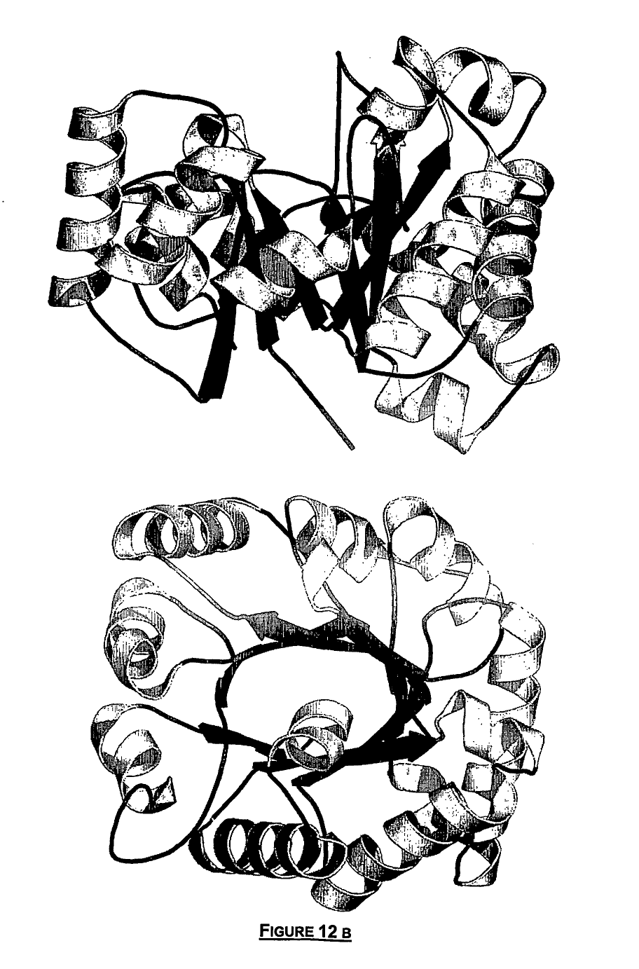

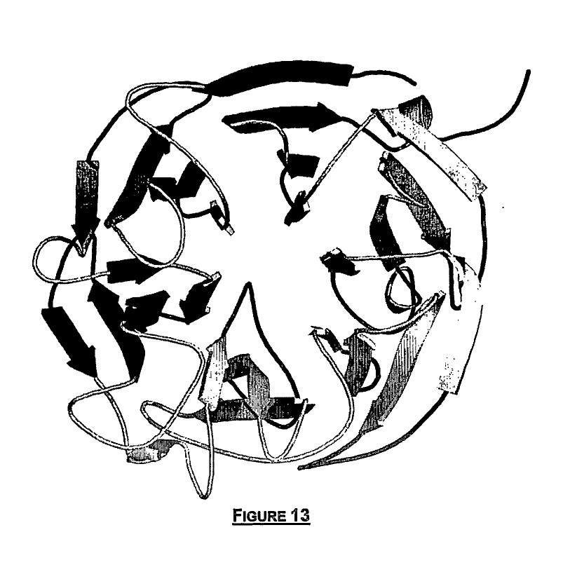

Preferably, components (iia) are constituted by cylinders (FIG. 1) or spirals (FIG. 12b), while components (iib) are represented by strands, arrows or flat oblong shapes (FIGS. 1, 12 and 13). In an even more particular embodiment, the model is constituted by one single type of component (iia), which is a cylinder, and a type of component (iib) with flat oblong forms.

According to the present invention, the elements of secondary structure of the proteins may be represented by one single component (ii) or by a number of said components. Components (ii a) and (ii b) show, in a particular embodiment, connections for fitting with other equal or different components. Still more particularly, components (ii a) present two fitting connections and components (ii b) present four fitting connections. According to a particular embodiment, components should present a female connection at one of their ends and a male connection at the opposed end (FIGS. 1a and 1d), with the latter fitting the female connection of the following component, which is preferably of the same type regarding its shape, allowing to build structures of any size.

Preferably, components (i) fit into the female connections of the components (ii).

According to the present invention, the components (ii) can also represent the orientation of the polypeptide chains. For this purpose, the end components (corresponding to the C-terminal region of the element of secondary structure) should present some identification. According to a particular embodiment, components (ii) used to identify the C-terminal region of the chains do not present a male connection, but rather two female connections. The terminal region of the chain is represented by a component ending in a non-connected end. The model can also comprise component complements, with a different shape, particularly triangles or cones, having at least one, preferably two female ends, one to fit the end component of the element of secondary structure and another one to connect the component (i). These triangular or conical complements of components are preferably different for α-helices and β-strands. According to an even more particular embodiment, the models may comprise, instead of different components formed by uniting a component and a complement to be fitted, the different components (i) and (ii) presenting a different shape, preferably an arrow form, not presenting the male connection and provided with an end having a female connection (FIGS. 1c and 1e).

Furthermore, the end region of the chains can be represented by using colors. In a particular embodiment of the present invention, the C-terminal region of the chain is represented by a red component and the N-terminal region by a blue component (FIGS. 1a, b and c) or, in cases where the N-terminal and/or C-terminal of the chain is not a part of an element of secondary structure, by means of a component (i) of the desired color, preferably red for C-terminal and blue for N-terminal.

The model of the present invention may comprise components (ii a) and/or (ii b) presenting different units by means of characteristics which may be the shape, color and/or material.

The models of the present invention may comprise a third component (iii) for schematic representation of the hydrogen bonds enabling the formation of β-sheets. Component (iii) is constituted by a pliable material with no memory which remains in the established position, particularly wires as component (i), of preferably smaller diameter (FIG. 1g).

Components (iii) are fitted into the sides of components (iib), which should then have fitting connections on the sides. Preferably, said connections are female connections. Components (i) and (iii) particularly present a slightly smaller diameter than the orifice of said female connections of the ends and sides, respectively. In a particular embodiment of the invention, components of the body of β-strands present a female connection on each side (FIGS. 1e and 1d), a pattern which does not correspond exactly to that which is found in nature, being used herein as a schematic representation. This is because, according to the invention, the models do not present a fixed scale and, since the number of amino acids corresponding to each component (iib) has not been previously defined, it would be difficult to establish the number of existing bonds. Components (iii) and the corresponding connections in components (iib) may be present in any quantity. Furthermore, components (iii) also perform the function to improve the mechanical stability of the model. Components (iii) are preferably white.

Furthermore, the model can also comprise at least one, particularly two types of reinforcement components providing greater stability to the model aiding in the construction of particular conformations, but not representing or corresponding, however, to any aspect of the protein structure itself, but especially useful in the representation of more complex structures.

In a particular embodiment of the present invention, such reinforcement components (iv) are fitted into the connections present in the components as previously described, particularly into the side female connections or by means of orifices at the ends allowing their introduction between the male connection of a component and the female connection of the following component, so to interfere as little as possible in the protein structure (FIGS. 6, 8 and 9). Therefore, said components are preferably constituted of transparent material which may be more rigid or more flexible, according to the region of the structure to which it will be connected, particularly polymers.

In a more particular embodiment, the model of the present invention additionally comprises the component (iv a) constituted of poorly flexible polymeric wires or short sticks fitting into female connections, which can still pass through one or more components (FIG. 1i). Components (iv a) may advantageously have their ends changed so to, on one side, facilitate the introduction of connections, at the same time making it difficult to release components, and, on the other hand, assure it to remain in the desired position and not simply passing through other components, especially when the model is handled. Preferably, component (iv a) presents one end in the form of a half arrowhead and the opposite one flattened.

The model of the present invention can additionally comprise the component (iv b) constituted of flexible polymeric strands presenting orifices at their ends for the passage of male connections (FIG. 1h) or components (i) and/or (iii).

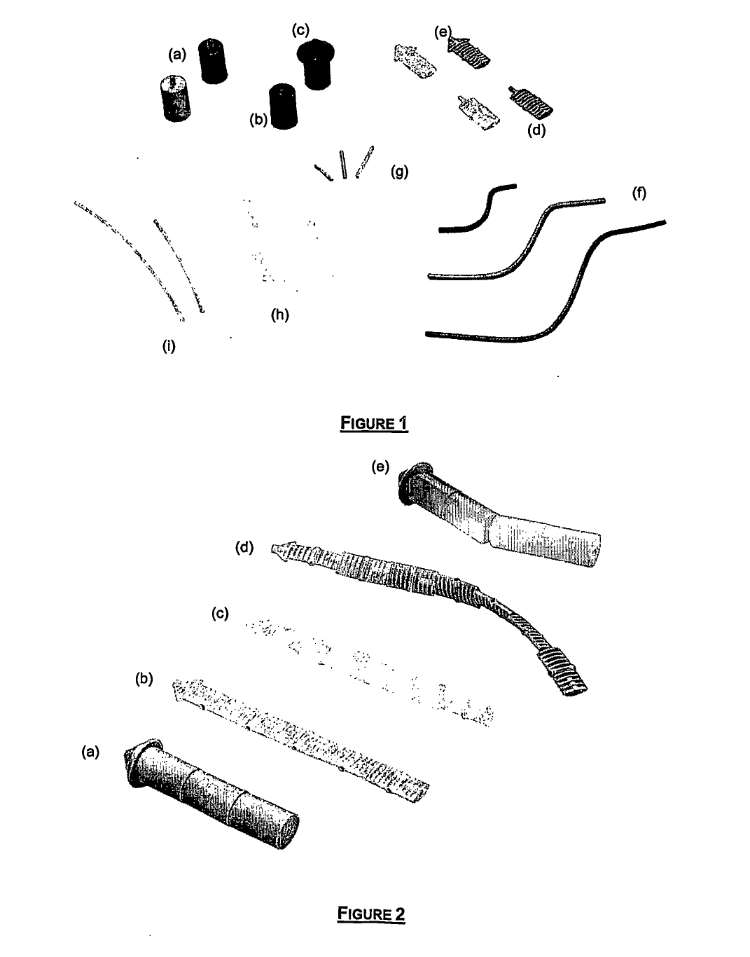

The components of the model are formed by single parts or by a set of hollow or solid parts, according to the material used and according to issues related to production. According to a particular embodiment of the present invention, the components of this model, particularly components (ii), are molded by polymer injection, with the aim of obtaining precision in their shapes and connections. However, the modular nature of the models allows for consecutive components, particularly β-strands, to suffer relative rotations with respect to one another, so that the chirality of the strands may be appropriately represented. Connections should be sufficiently adjusted (tight fitting) for these components to keep their relative position even after rotation (FIGS. 2 & 3).

The components of the invention can be constituted by any material, set or mixture of materials, such as e. g. metals, polymers, woods or ceramics. One single model can also comprise components produced from different materials. Components can also present differences such as e. g. in texture, cut, thickness, recesses or grooves, colors or transparency, having or not the purpose to identify different regions in the structures. In a particular embodiment, components of the invention are colored and the colors may be used to distinguish regions of the chain as described above and the reinforcement components are transparent (FIGS. 2, 5, 6 and 10.) Furthermore, colors can be used to represent e. g. different protein domains, active sites, structural motifs, secondary structures, modified regions or regions with structural and/or functional interest, to distinguish between loops and turns and for highlighting a given region, among other purposes.

In a particular embodiment of the present invention, components (iib) are constituted by flexible material, but are able to assure that the chirality of the strands is appropriately represented. Furthermore, they do not have prominences, have an elliptical cross section and recesses or grooves to improve their mechanical properties. These features help components and structures built from them to be bent and twisted without breaking, so as to enable the representation of the full complexity of protein structures.

The present invention is still more advantageous, since the model may be used for representations not necessarily according to any given scale. The branch of mathematics known topology does not include any notion of scale, thus allowing the same protein structure to be built with different sizes.

For some applications, however, the user may be interested in establishing a scale, so as to represent the correct relationship between the sizes of the elements of the protein structure, where the model now includes components with dimensions that are proportional to that which is found in nature. An example of a scale which may be used for the components of the invention is described below: each component (iia) represents a turn of the α-helix (5.6 Å long) and each component (iib) represents a turn of the β-strand (6.3 Å long). The scale can be adjusted according to the user's interests. Each component can represent not one turn, but half turn or alternatively two turns. In the case where one component corresponds to a turn of the strand, each component (iib) will correspond to approximately two residues and the side connections (one at each side) to a pair of hydrogen bonds from each one of the two residues.

Since they are preferably pliable, but keep their shape once bent, components (i) may be molded by the user so to represent the real course of the peptide chain as precisely as required. Said components may be of any size and represent the exact shape of loops and their position regarding the elements of secondary structure or can merely represent the connectivity between the elements of secondary structure with no reference to their real shape. Loops of the same size and shape can be used to emphasize e. g. the pseudo-symmetry of a given fold. The present invention therefore allows the representation of a particular structure or a particular fold.

According to the present invention, components can therefore be of any size. Preferably, components (ii) have the same size.

Therefore, the model of the present invention is more versatile and adaptable than the models known in the state of the art. The models are not necessarily fixed and can be easily assembled and handled. In principle, any protein structure (represented in terms of its elements of secondary structure) can be built by using an appropriate combination of the parts described in the invention. They can be used to represent protein regions that do not form elements of secondary structure, secondary, tertiary and quaternary structures of proteins, changes in these structures and even interactions among proteins. Furthermore, numerous peculiarities of the structures can be represented, such as e. g. those described herein.

Therefore, the model of the present invention can have various purposes, among them we highlight teaching applications, and in aiding in research in the field and for the illustration of scientific work.

The present invention also refers to kits comprising at least one of the described components, preferably at least one of each of the four described components i, ii, iii and iv.

Components can be presented as appropriately as possible according to the user's interest, comprising individual components with equal or different features or a mix of different components.

According to a particular embodiment of the present invention, the kit comprises components (i) and (ii) with the same features, but allowing for differences of interest, such as e. g. color, or at least one of the particular features as described herein.

In an even more preferred embodiment, the kit of the invention comprises at least:
120 components (i), present in six colors (red, yellow, blue, green, black and white), distributed as follows:
   72 components of 12 cm long, being each a dozen of one color;
   18 components of 17 cm long, being each group of three of one color;
   12 components of 22 cm long, being each two of one color, and
   18 components of 40 cm components, being each three of one color.
455 components (ii) distributed as follows:
   165 components (iia) divided as follows:
      110 components representing the body of α-helices, being 50 red components, 20 green, 20 yellow and 20 blue;
      55 components representing the end regions of α-helices, being 25 red components, 10 green, 10 yellow and 10 blue;
   290 components (iib) divided as follows:
      205 components representing the body of β-strands, being 100 green components, 35 red, 35 yellow and 35 blue.
      85 components representing the end region of β-strands, being 40 green components, 15 red, 15 yellow and 15 blue.
250 components (iii), all of them white and distributed as follows:
   75 components of 2.8 cm long;
   100 components of 3.3 cm long; and
   75 components of 3.8 cm long.
components (iv):
   3 meters of the transparent component (iv a); and
   60 transparent components (iv b) distributed as follows:
      30 components of 5.5 cm long; and
      30 components of 8.5 cm long.

The expert in the art will know how to evaluate that the invention may be embodied in different ways in the light of the information described herein.

The examples below represent only illustrative and in no way limitative embodiments, of the invention.

### EXAMPLES

### Example 1

### α-Helices, β-Strands and their Common Distortions

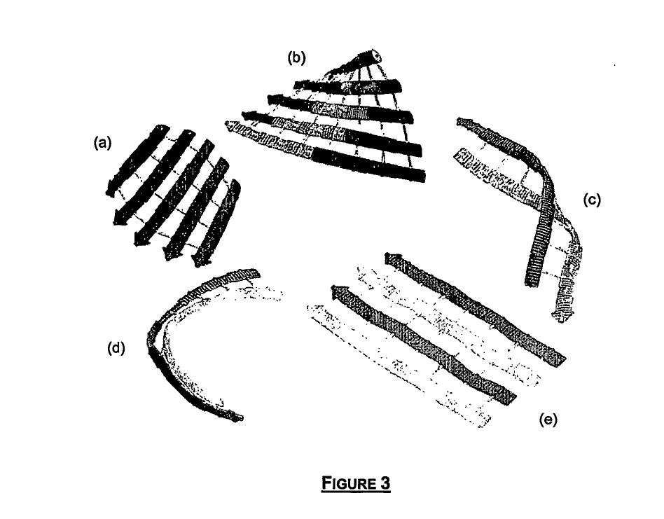

This example shows that, by joining the basic components as described above, it is possible to form basic structures representing elements of secondary structure. Linear β-strands and α-helices, as shown by FIG. 2a and FIG. 2b, are formed by means of simply joining the relevant parts. A twisted β-strand may be produced by slight rotation of the consecutive units of the β-strand (FIG. 2c). So as to correctly represent the right-handed chirality of a β-strand (as measured considering every second residue), the parts should be turned clockwise as one moves further from the observer along the axis of the helix. A coiled twisted β-strand (FIG. 2d) can be initially produced by closing the strand into a circle so as to induce an arch, then releasing this by way of opening one of the connections and finally by applying the twist as described above for the twisted strand. β-bulges can be generated by including an extra strand component in a strand as compared with its pair (FIG. 3d). A kink in an α-helix, such as caused by a proline, can be produced by introducing a connection of small flexible wire between e.g. a plain end helix component and a conical end helix component. Helices of different types (e.g. 3₁₀ and π) can be distinguished from α-helices in a structure by simply using different colors.

### Example 2

### β Strands (Saddles, Barrels and Double-Stranded Coiled Coils)

By joining twisted β-strands with components representing pseudo hydrogen bonds, it is possible to generate similar structures to the saddle shown in FIG. 3a. This structure includes a rectangular hydrogen-bond array as described by Salemme (Salemme, F. R. (1983) Structural Properties of Protein Beta Sheets, Prog. Biophys. Mol. Biol. 42, 95-133), which can be either parallel (as shown) or antiparallel. A rhombohedral array, on the other hand, tends to form barrel structures (FIG. 3b), to be detailed in the examples that follow. This tendency is shown by the lighter elements in the similar structure to the saddle of FIG. 3b. Two twisted β-strands can form a coiled coil of β-strands joined by hydrogen bonds as shown by FIG. 3c.

### Example 3

### A (β/α)₈ Barrel or TIM (Triose-Phosphate-Isomerase)

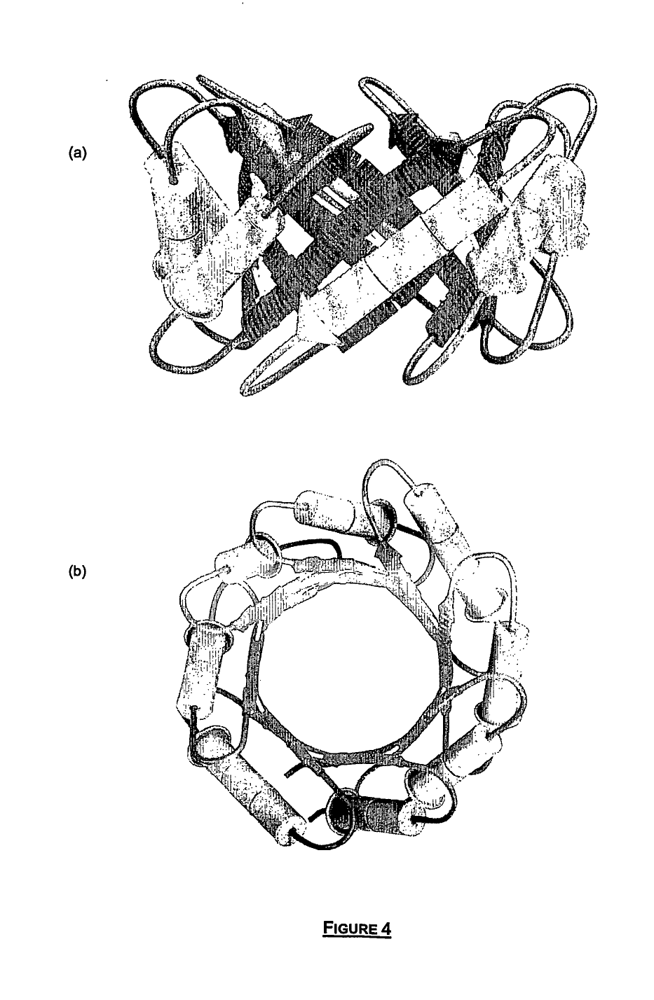

This example shows one of the most common topologies observed in enzyme structures. Eight parallel β-strands form a barrel structure in which hydrogen bonds joining the strands are arranged in the form of a rhombohedral array. The strands are parallel among themselves and anti-parallel with respect to the eight α-helices located outside the strands. The rhombohedral disposition of hydrogen bonds causes an inclination of the β-strands relative to the barrel axis. This can be characterized by the “shear number” of the barrel, describing the displacement (in number of residues) along any given strand when a turn of the barrel is completed by moving from strand to strand along the direction of the hydrogen bonds. This can be appropriately modeled by the choice of an appropriate scale for the model. If a shear number of 8 for an eight-stranded barrel is desired (as shown by FIG. 4), a displacement of one residue is required when moving from one strand to the next. This requires the user to choose a scale in which one β-strand component corresponds to one residue. An expert in the art will be able to find out the numerous alternatives given by the model to the user. In this model, helices are represented by conical ended cylinders.

### Example 4

### NAD⁺ Binding Domain (Composed of Two Rossmann's Folds)

In this example, a NAD⁺ binding domain is shown, as observed e.g. in dehydrogenases. A central β-sheet in the form of a saddle is composed of six parallel twisted β-strands. This central β-sheet is surrounded by α-helices on both its sides.

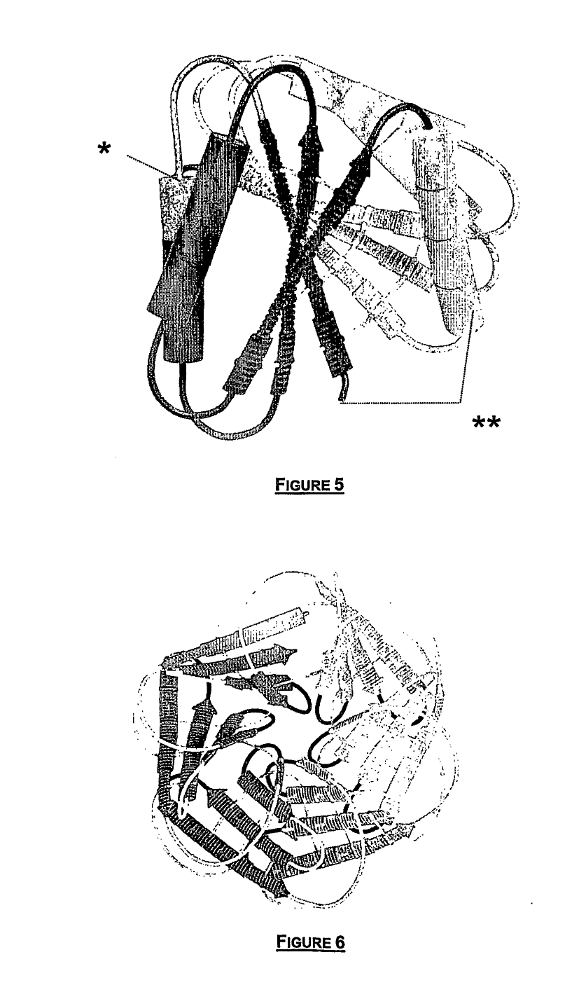

The structure is divided into two parts, each one consisting of three β-strands and two associated α-helices. These are known as Rossmann folds and are shown in darker and lighter shades for the N- and C-terminal halves of the structure, respectively (FIG. 5). The helix connecting both is shown in an intermediary shade of black on the front right-hand side of the figure (**). The N-terminal region of the first helix and the preceding loop were originally highlighted by means of components of a fourth color to show their importance in NAD⁺ binding (*). In the present black and white representation the N-terminal region of the α-helix is represented by an intermediary shade of black, together with, on the bottom left of the figure, the small part of component (i) connected just to one of the β-strands which appears in a darker shade. In this figure, the ends used for the α-helices are straight, showing an alternative to that which was presented in the previous example. This example shows clearly how the use of colors can be advantageous and effectively employed to emphasize biologically important information.

### Example 5

### Six Bladed β-Propeller (As Observed in Neuraminidase)

Structures in the form of a β-propeller have internal pseudo symmetry. Various examples are known in nature, including helices with four, six, seven or eight “blades”. The blades of the structures of FIG. 6 comprise four anti-parallel β-strands. The example shows that said strands forming the β-sheet do not need to be the same length. This six-bladed configuration corresponds to that observed in neuraminidase and was originally built by components with six different colors, herein represented by light and dark shades, clarifying the pseudo symmetry.

Since there are no hydrogen bonds passing from one β-sheet to another, as they are effectively independent, the final structure may be less rigid than desired, which is overcome in this example by the use of the transparent component (iv a) linking nearby blades, which merely serves as a mechanical reinforcement to the structure. These connections are possible due to the advantage that, in an open β-sheet (not forming a barrel) or a β-sheet having strands with different lengths, some of the side connections will necessarily not be used to form pseudo hydrogen bonds.

### Example 6

### Four-Helix Bundle

48 topologies are known for four-helix bundles (Presnell, S. R. & Cohen, F. E. (1989) Proc. Natl. Acad. Sci. 86, 6592-6596). Six of them are considered as fully anti-parallel, since each of the four helices presents two anti-parallel neighbors. FIG. 8 shows two of these bundles—FIG. 8a shows a right-turning bundle with topology RTO and FIG. 8b shows a left-turning one of topology LTO. In this example, different shades of gray represent the helix sequence along the polypeptide chain, also emphasized by the representation of terminal regions of the helices by a component in the form of an arrow or cone, a pattern which could also be easily represented e.g. by the use of colored components. The figure was originally built by components with different colors, with each one of the four a-helices being of one color, from blue to red, following a rainbow-based color scale, from the N-terminal to the C-terminal region. The same pattern was used for the structures shown in a and b, so as to highlight the differences in their topologies.

An expert in the art knows that there are preferential packing angles between α-helices in protein structures, including helix bundles. In classic bundles, this angle is about +20° and can be easily established while assembling the model by bending the components (i) which form the connections between helices.

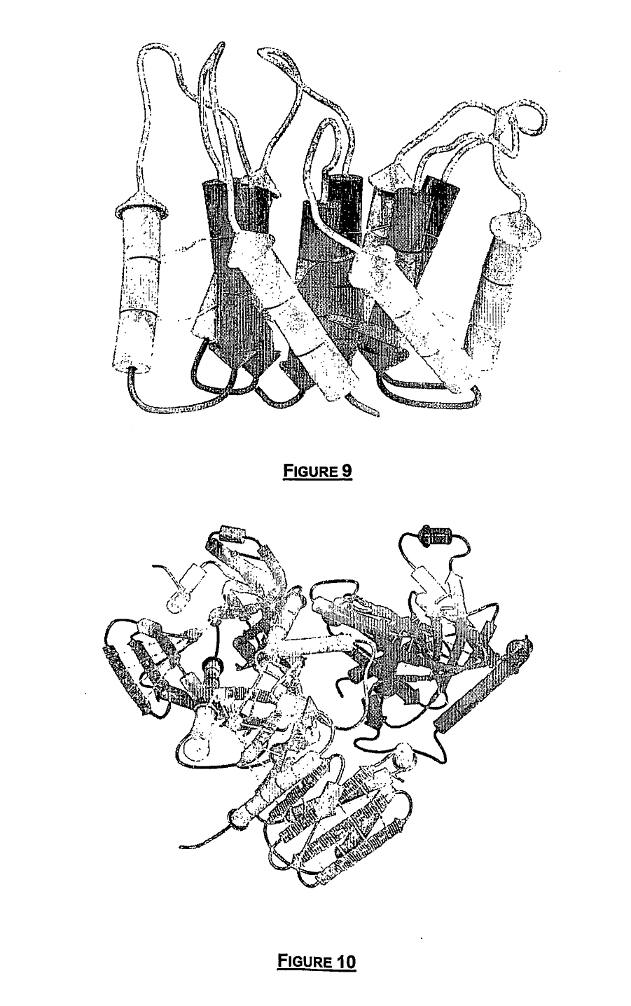

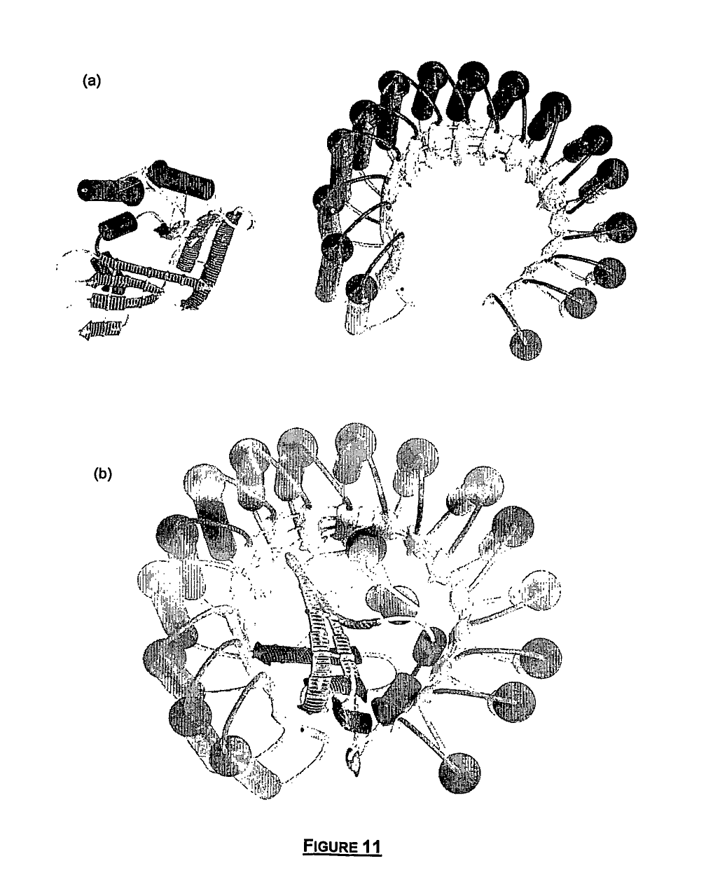

Since α-proteins have few or no β-sheets, the corresponding model does not benefit from the mechanical stability introduced by the pseudo hydrogen bonds, resulting in less rigidity than required. Mechanical stability can be reinforced by components (iv b) positioned between helices. Transparency is again preferred so that these components, not representing aspects of the protein per se, become less evident in the final model. FIG. 9 shows another example of the use of said components for the structure of an (α/α)₆ barrel which also possesses no β-sheet.

### Example 7

### Jelly-Roll

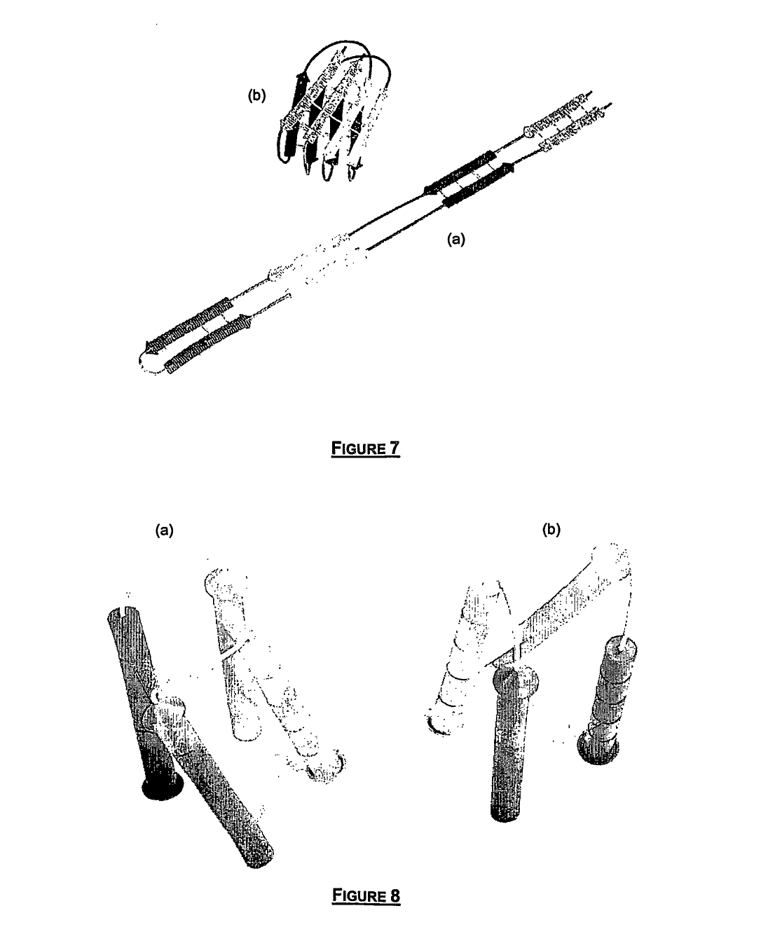

A jelly-roll is formed by twisting a hairpin structure composed of β-strands around the external side of a barrel. This example, as shown by FIG. 7, shows the dynamic use of the model. The flexibility of connections between the elements of secondary structure (loops and turns) and the simplicity of the model assure that structures can be assembled by the teacher or students in a classroom, in an entertaining and interactive way, so that the students can easily perceive the formation of more complex structures from basic elements.

### Example 8

### Purine Nucleoside Phosphorilase

Oligomeric proteins are composed of more than one polypeptide chain. As an example, Purine Nucleoside Phosphorilase is an enzyme of the purine salvage pathway, which is active in the form of a trimer. In FIG. 10, each of the enzyme subunits is highlighted by using a different shade of black. Said shades correspond to the different colors as used in the original model. This example shows the potential of the invention to build oligomeric protein structures. When required, components (iv) may be used to join the various chains of an oligomeric protein.

### Example 9

### Ribonuclease and its Porcine Inhibitor

The models of the invention can also be used to easily show the importance of shape complementarity during the phenomenon of molecular recognition. FIG. 11 shows the structures of ribonuclease and its porcine inhibitor separately (FIG. 11a) and in the form of a hypothetical complex (FIG. 11b). In the latter case, ribonuclease fits into the central cavity present in the structure of the inhibitor, demonstrating the complementarity between the two structures. Said complementarity is one of the bases for the biological action of proteins and its understanding is basic for the full comprehension of biological phenomena at the molecular level. Used as such, the invention facilitates the teaching of this concept, thus highlighting its pedagogical use.

1-47. (canceled)

48. A non-simile three-dimensional topological model to represent a protein structure or a part of a protein structure, comprising:
at least one of
(i) components to represent regions of proteins not forming elements of secondary structure and which are used to join components (ii);
(ii) components to represent elements of secondary structure;
(iii) component for the schematic representation of hydrogen bonds; and
(iv) reinforcement component for the mechanical stabilization of the model,
wherein the components (i) and (ii) are relatively joined to each other by the same type of junction.

49. The model according to claim 48, wherein the components (ii) include at least one of
(ii a) component to represent elements of secondary structure, the element being α-helices (or 3₁₀ or π helices), and
(ii b) component to represent elements of secondary structure, the element being β-strands,
and the (iv) reinforcement component includes at least one of
(iv a) reinforcement component for the mechanical stabilization of the model in the form of at least one of wires or small rods, and
(iv b) reinforcement component for the mechanical stabilization of the model in the form of strips.

50. The model according to claim 49, wherein the components (i) and (iii) present an elongated form.

51. The model according to claim 49, wherein the component (ii a) presents at least one of a cylindrical or spiral form.

52. The model according to claim 49, wherein the component (ii b) presents a flattened elongated form.

53. The model according to claim 52, wherein the component (ii b) presents an elliptical cross-section and grooves on the surface.

54. The model according to claim 49, wherein the components are formed by one of a single piece or a set of hollow or solid pieces.

55. The model according to claim 49, wherein structural elements of the proteins are constituted by one or more components.

56. The model according to claim 49, wherein the components (ii a) and (ii b) present connections for fitting with other equal or different components.

57. The model according to claim 56, wherein the components (ii a) present two fitting connections and the components (ii b) present four fitting connections.

58. The model according to claim 56, wherein the components (ii a) and (ii b) present a female fitting connection at one end.

59. The model according to claim 58, wherein the components (ii a) and (ii b) of the model present one of a male or female fitting connection at the other end.

60. The model according to claim 49, wherein the model comprises at least one of components (ii a) and (ii b) presenting different units by means of features including at least one of their form, color, or material.

61. The model according to claim 60, wherein the model comprises at least one of components (ii a) and (ii b) in the form of at least one of an arrow or cone.

62. The model according to claim 61, wherein at least one of the components (ii a) and (ii b) present a female fitting connection at each end.

63. The model according to claim 60, wherein at least one of the components (ii a) and (ii b) are formed by a component of the model and a complement.

64. The model according to claim 56, wherein at least one of the components (ii a) and (ii b) present side connections for fitting to other components of the model.

65. The model according to claim 64, wherein the components (ii b) present at least one female connection at each side to be fitted to the components (iii).

66. The model according to claim 48, wherein the components (i) are fitted to female connections at the ends of the components (ii).

67. The model according to claim 48, wherein the components (iii) are fitted to female connections on the sides of the components (ii).

68. The model according to claim 48, wherein the components (i) and (iii) present smaller diameter than a hole of the female connections of the ends and sides, respectively.

69. The model according to claim 49, wherein the model comprises at least one of components (i) and (iii) in the form of wires.

70. The model according to claim 49, wherein the model comprises components (iv a) in the form of at least one of wires or small rods.

71. The model according to claim 70, wherein the model comprises components (iv a) with an end in the form of a half arrowhead and the other opposite end flat.

72. The model according to claim 49, wherein the model comprises components (iv b) in the form of strips.

73. The model according to claim 72, wherein the model comprises components (iv b) presenting holes at their ends.

74. The model according to claim 49, wherein the components (iv a) are connected to side female fitting connections of the components (ii b).

75. The model according to claim 49, wherein the components (iv b) are connected to at least one of male connections of the components (ii) or to components (i).

76. The model according to claim 49, wherein the components are constituted by at least one of wood, polymers, metals, or ceramics.

77. The model according to claim 76, wherein at least one of the components (i) and (iii) is a flexible wire with no memory, which remains in a given position after removing a force tending to deform it.

78. The model according to claim 77, wherein at least one of the components (i) or (iii) are constituted of an inner material filament covered with polymeric material.

79. The model according to claim 76, wherein the components (ii) and (iv) are constituted of a polymeric material.

80. The model according to claim 79, wherein the components (ii b) and (iv b) are constituted of flexible polymeric material.

81. The model according to claim 49, wherein the model comprises components of different colors.

82. The model according to claim 81, wherein the model comprises components (ii) of at least two different colors including blue and red.

83. The model according to claim 81, wherein the model comprises components (i) of the same color as components (ii).

84. The model according to claim 81, wherein the model comprises components (iii) in a white color.

85. The model according to claim 81, wherein the model comprises transparent components (iv).

86. The model according to claim 49, wherein the model comprises components with measurements representing a proportional scale to that which is found in nature.

87. The model according to claim 86, wherein the model comprises components representing a given number of residues in a peptide chain.

88. The model according to claim 49, wherein the model comprises components (ii a) and (ii b) with the same length.

89. The model according to claim 48, wherein the components (i) and (ii) are relatively joined to each other by a circular cross-sectional male-female (pin-into-hole) connection.

90. A kit to represent a three-dimensional model for a protein structure or a part of a protein structure, comprising:
at least one of
(i) components to represent regions of proteins not forming elements of secondary structure and which are used to join components (ii);
(ii) components to represent elements of secondary structure, including at least one of
(ii a) component to represent elements of secondary structure, the element being α-helices (or 3₁₀ or π helices), and
(ii b) component to represent elements of secondary structure, the element being β-strands;
(iii) component for the schematic representation of hydrogen bonds; and
(iv) reinforcement component for the mechanical stabilization of the model, including at least one of
(iv a) reinforcement component for the mechanical stabilization of the model in the form of at least one of wires or small rods, and
(iv b) reinforcement component for the mechanical stabilization of the model in the form of strips,
wherein the components (i) and (ii) are relatively joined to each other by the same type of junction.

91. The kit according to claim 90, which comprises at least:
components (i) distributed as 72 components of 12 cm long, 18 components of 17 cm long, 12 components of 22 cm long, and 18 components of 40 cm long;
components (ii) distributed as 165 components (ii a) divided as 110 components representing the body of α-helices, and 55 components representing the end regions of α-helices, and
components (ii b) divided as 205 components representing the body of β-strands, and 85 components representing the end region of β-strands;
components (iii) distributed as 75 components of 2.8 cm long, 100 components of 3.3 cm long, and 75 components of 3.8 cm long; and
components (iv) including
3 meters of the component (iv a), and
60 components (iv b) distributed as 30 components of 5.5 cm long, and 30 components of 8.5 cm long.

92. The kit according to claim 91 which comprises at least:
components (i) present in red, yellow, blue, green, black and white distributed as 72 components of 12 cm long with each dozen of one color, 18 components of 17 cm long with each group of three of one color, 12 components of 22 cm long with each two of one color, and 18 components of 40 cm long with each three of one color;
components (ii) distributed as
components (ii a) divided as
110 components representing the body of α-helices with 50 red components, 20 green components, 20 yellow components and 20 blue components, and
55 components representing the end regions of α-helices distributed as 25 red components, 10 green components, 10 yellow components, and 10 blue components, and
components (ii b) divided as
205 components representing the body of β-strands distributed as 100 green components, 35 red components, 35 yellow components and 35 blue components, and
85 components representing the end region of β-strands distributed as 40 green components, 15 red components, 15 yellow components, and 15 blue components;
components (iii), all of them white and distributed as 75 components of 2.8 cm long, 100 components of 3.3 cm long, and 75 components of 3.8 cm long; and
components (iv) including 3 meters of a transparent component (iv a) and 60 transparent components (iv b) distributed as 30 components of 5.5 cm long and 30 components of 8.5 cm long.
